(19) United States
(12) Patent Application Publication
(10) Pub. No.: US 2023/0099904 A1
(43) Pub. Date: Mar. 30, 2023

(54) MACHINE LEARNING MODEL PREDICTION OF INTEREST IN AN OBJECT

(71) Applicant: Capital One Services, LLC, McLean, VA (US)

(72) Inventors: Xiaoguang ZHU, New York, NY (US); Lin Ni Lisa CHENG, New York, NY (US)

(21) Appl. No.: 17/449,356

(22) Filed: Sep. 29, 2021

(51) Int. Cl. G06Q 30/06; G06N 3/02

(52) U.S. Cl. CPC G06Q 30/0631; G06Q 30/0639; G06Q 30/0643; G06N 3/02; G06Q 30/0619

(57) ABSTRACT

In some implementations, a device may identify an exchange, associated with an object, between a first user and an entity. The device may determine that the entity is associated with at least one characteristic that satisfies a condition. The device may transmit, to a device of the first user and based on determining that the entity is associated with the at least one characteristic that satisfies the condition, a first notification prompting the first user to provide information associated with the object. The device may receive the information associated with the object. The device may determine based on the information associated with the object and using a machine learning model, at least a second user predicted to have a level of interest in the object that satisfies a threshold. The device may transmit, to a device of the second user, a second notification that identifies the object.

### BACKGROUND

Various platforms enable a user to access and/or identify, via user device, objects or items that may be of interest to the user. For example, the user (e.g., a consumer) may utilize a web browser, web pages of merchants, social media, and/or applications on the user device to browse information on the objects, images depicting the objects, audio media associated with the objects, and/or video media associated with the objects, and so on. Accordingly, the user may identify a particular characteristic of the object, such as a size of the object, a shape of the object, a type of the object, a color of the object, a producer or manufacturer of the object, a cost of the object, a location of the object, and/or a style of the object, among other types of characteristics.

### SUMMARY

Some implementations described herein relate to a system for predicting interest in an object. The system may include one or more memories and one or more processors communicatively coupled to the one or more memories. The one or more processors may be configured to identify an exchange, associated with the object, between a first user and an entity. The one or more processors may be configured to determine that the entity is associated with at least one characteristic that satisfies a condition. The one or more processors may be configured to transmit, to a device of the first user and based on determining that the entity is associated with the at least one characteristic that satisfies the condition, a first notification prompting the first user to capture an image of the object. The one or more processors may be configured to receive, from the device of the first user, the image of the object that is captured by the device of the first user. The one or more processors may be configured to determine, based on the image and using a machine learning model, at least a second user predicted to have a level of interest in the object that satisfies a threshold. The machine learning model may be trained to identify levels of interest in the object associated with a plurality of users based on a style of the object and the at least one characteristic of the entity. The one or more processors may be configured to determine whether the entity has additional supply of the object. The one or more processors may be configured to transmit, to a device of the second user based on determining the second user and determining that the entity has the additional supply of the object, a second notification that identifies the object.

Some implementations described herein relate to a method of predicting interest in an object. The method may include identifying, by a device, an exchange, associated with the object, between a first user and an entity. The method may include determining, by the device, that the entity is associated with at least one characteristic that satisfies a condition. The method may include transmitting, to a device of the first user and based on determining that the entity is associated with the at least one characteristic that satisfies the condition, a first notification prompting the first user to provide information associated with the object. The method may include receiving, by the device from the device of the first user, the information associated with the object. The method may include determining, by the device, based on the information associated with the object and using a machine learning model, at least a second user predicted to have a level of interest in the object that satisfies a threshold. The machine learning model may be trained to identify levels of interest in the object associated with a plurality of users based on the at least one characteristic of the entity. The method may include transmitting, by the device to a device of the second user based on determining the second user, a second notification that identifies the object.

Some implementations described herein relate to a non-transitory computer-readable medium that stores a set of instructions for predicting interest in an object for a device. The set of instructions, when executed by one or more processors of the device, may cause the device to identify an exchange, associated with the object, between a first user and an entity. The set of instructions, when executed by one or more processors of the device, may cause the device to determine that the entity is associated with at least one characteristic that satisfies a condition. The set of instructions, when executed by one or more processors of the device, may cause the device to transmit, to a device of the first user and based on determining that the entity is associated with the at least one characteristic that satisfies the condition, a first notification prompting the first user to capture an image of the object. The set of instructions, when executed by one or more processors of the device, may cause the device to receive, from the device of the first user, the image of the object that is captured by the device of the first user. The set of instructions, when executed by one or more processors of the device, may cause the device to determine, based on the image, at least a second user predicted to have a level of interest in the object that satisfies a threshold. The set of instructions, when executed by one or more processors of the device, may cause the device to transmit, to a device of the second user based on determining the second user, a second notification that identifies the object.

### BRIEF DESCRIPTION OF THE DRAWINGS

FIGS. 1A-1E are diagrams of an example implementation relating to prediction of interest in an object.

FIG. 2 is a diagram illustrating an example of training and using a machine learning model in connection with prediction of interest in an object.

FIG. 3 is a diagram of an example environment in which systems and/or methods described herein may be implemented.

FIG. 4 is a diagram of example components of one or more devices of FIG. 3.

FIG. 5 is a flowchart of an example process relating to prediction of interest in an object.

### DETAILED DESCRIPTION

The following detailed description of example implementations refers to the accompanying drawings. The same reference numbers in different drawings may identify the same or similar elements.

An entity may provide a user interface, such as a website, a mobile application, or the like, to indicate objects (e.g., products, artifacts, or other items) that are available for sale by the entity. A user may perform a transaction with the entity for one or more objects via the user interface. Typically, the user interface is supported by a backend system that provides tracking and management of objects that are presented via the user interface. For example, the backend system may facilitate entry of information relating to new objects, removal of information relating to outdated or discontinued objects, tracking of a supply (e.g., a stock) of objects, or the like. Accordingly, the backend system may be suitable for management of an inventory of objects that is relatively static (e.g., the objects are standardized, regularly available, produced in large quantities, or the like), which may generally be associated with large entities. However, the backend system may not be suitable for management of an inventory of objects that is relatively dynamic, which may generally be associated with small entities. For example, the objects may be produced in small batches, offered seasonally, limited edition, custom made, or the like. In such cases, use of the backend system for management of a dynamic inventory may require excessive entry and removal of objects, thereby consuming significant computing resources (e.g., processor resources and/or memory resources) and/or network resources.

Furthermore, a service provider may employ a system that may monitor and/or track user activity to enable the system to learn or identify particular interests of a user. Using the learned interests, the system can offer and/or provide information associated with objects that are most likely of interest to the user. The system may learn and/or identify interests of a user based on historical online browsing behavior, search queries, transactions, or the like. However, certain interests or classifications associated with an object may not be readily identifiable and/or indicated by such information. For example, a user may be interested in receiving information associated with objects available from an entity (e.g., a source of the object, a vendor of the object, a supplier of the object, or the like) that is associated with a characteristic satisfying a condition. More specifically, the user may be interested in receiving information associated with objects available from a small entity (e.g., based on a quantity of employees of the entity, a revenue of the entity, and/or a quantity of locations of the entity, among other examples). Accordingly, the system described above may be unable to identify that a user has an interest in a particular characteristic associated with an entity, and therefore the system may provide information associated with objects that are available from entities that are not likely of interest to the user. Providing information that is not likely of interest to a user may consume computing resources (e.g., processor resources and/or memory resources) and/or network resources that could otherwise be conserved.

Some implementations described herein provide a prediction system for predicting interest in an object in connection with one or more users. In some implementations, the prediction system may monitor exchanges (e.g., transactions) of users to identify an exchange for an object between a user and an entity associated with a characteristic that satisfies a condition (e.g., a size of the entity satisfies a threshold). The prediction system may transmit, to a device of the user, a notification prompting the user to capture an image of the object, and the prediction system may receive, from the device of the user, the image of the object. The prediction system may process the image using a machine learning model (e.g., a computer vision model) to determine a different user that is predicted to have a threshold level of interest in the object based on characteristics of the object as well as the characteristic of the entity. In some implementations, the prediction system may determine whether the entity has additional supply of the object by initiating an automated telecommunication call (e.g., that uses a conversational artificial intelligence technique) and/or by processing a content of a web page of the entity. Based on determining the different user (and in some examples, determining that the entity has the additional supply), the prediction system may transmit, to a device of the different user, a notification that identifies the object. In some implementations, the notification may include an input element to enable the different user to execute an exchange for the object.

The prediction system distributes information relating to objects that are available from entities that are associated with the characteristic that satisfies the condition. For example, the prediction system distributes information relating to objects that are available from small entities. Often, such objects may be produced in small batches, offered seasonally, limited edition, custom made, or the like, as described above. Accordingly, the prediction system facilitates exchanges for the objects without a need to enter and remove information relating to the objects from a backend system as described above, thereby conserving computing resources and/or network resources.

Moreover, the prediction system is capable of identifying an interest of a user in an object based on a characteristic of an entity offering the object, which is not readily ascertainable from the user's historical online browsing behavior, search queries, transactions, or the like. Accordingly, the prediction system may accurately determine a level of interest that a user may have in an object and may provide information about the object to the user based on the determination. In this way, the prediction system conserves computing resources and/or network resources that would otherwise be consumed using a system that cannot accurately determine a level of interest that a user may have in an object.

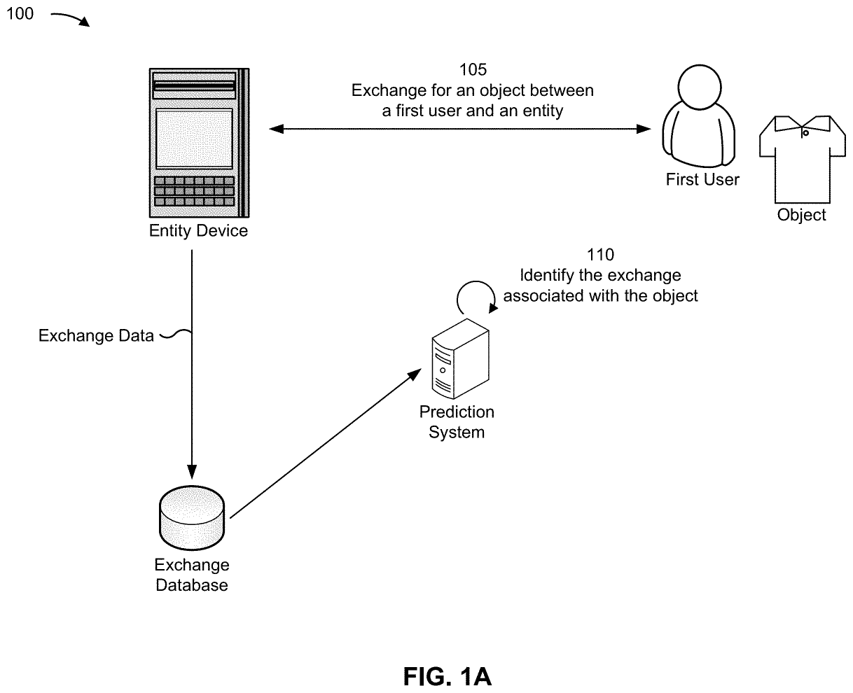

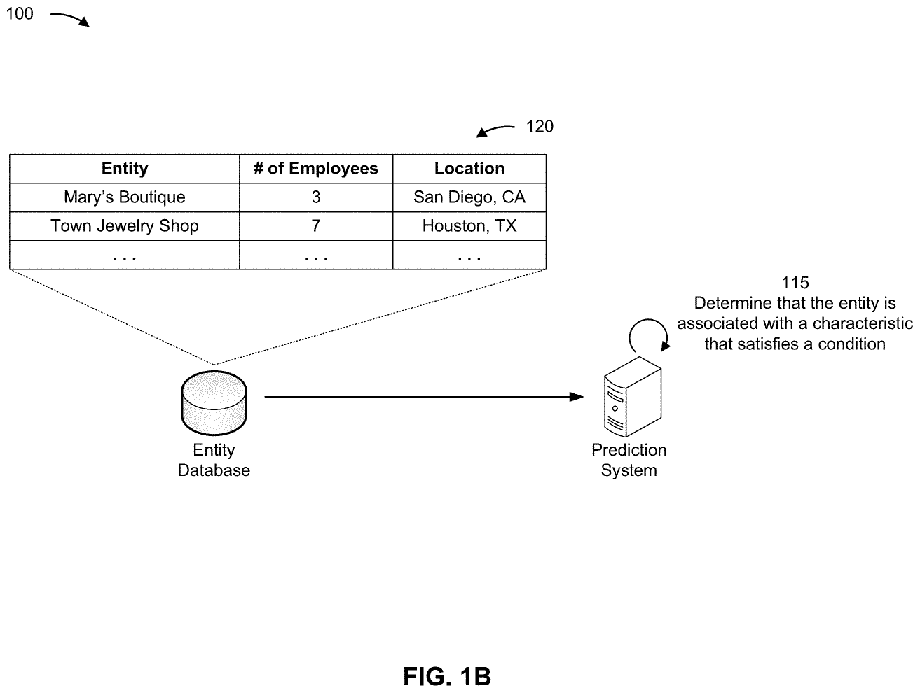

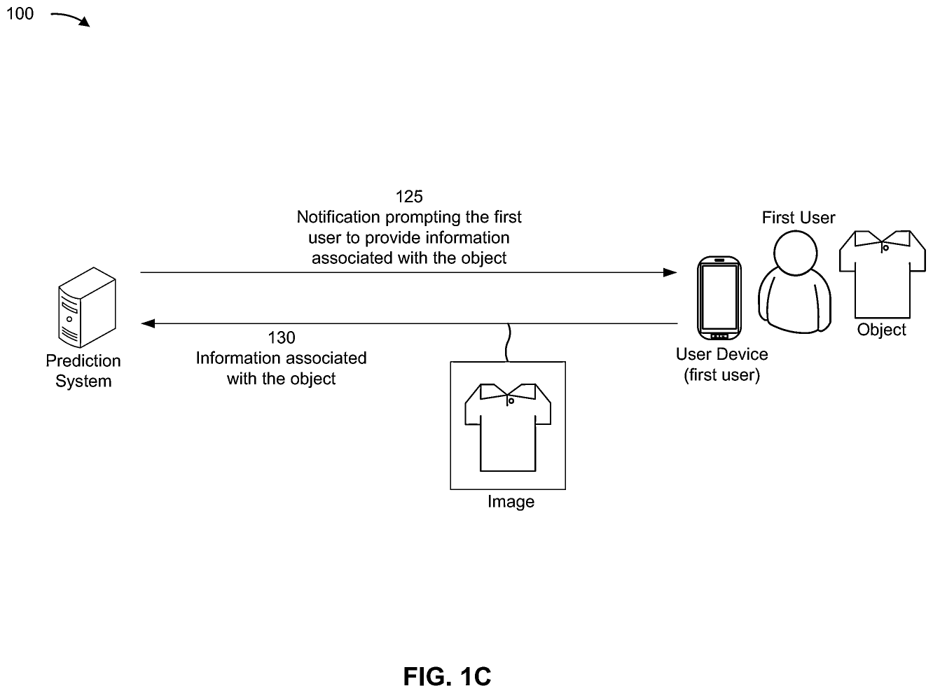

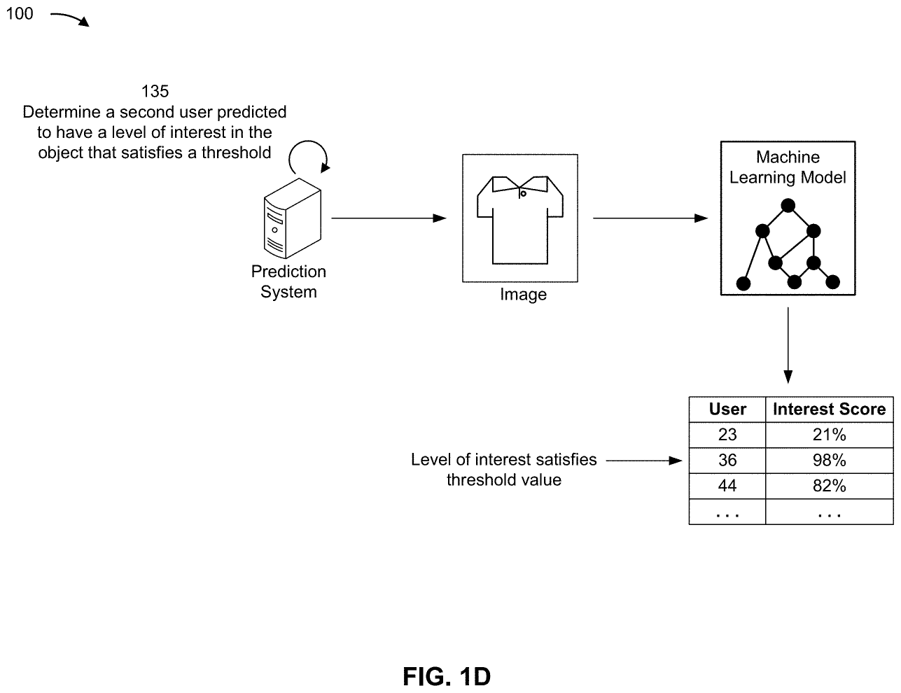

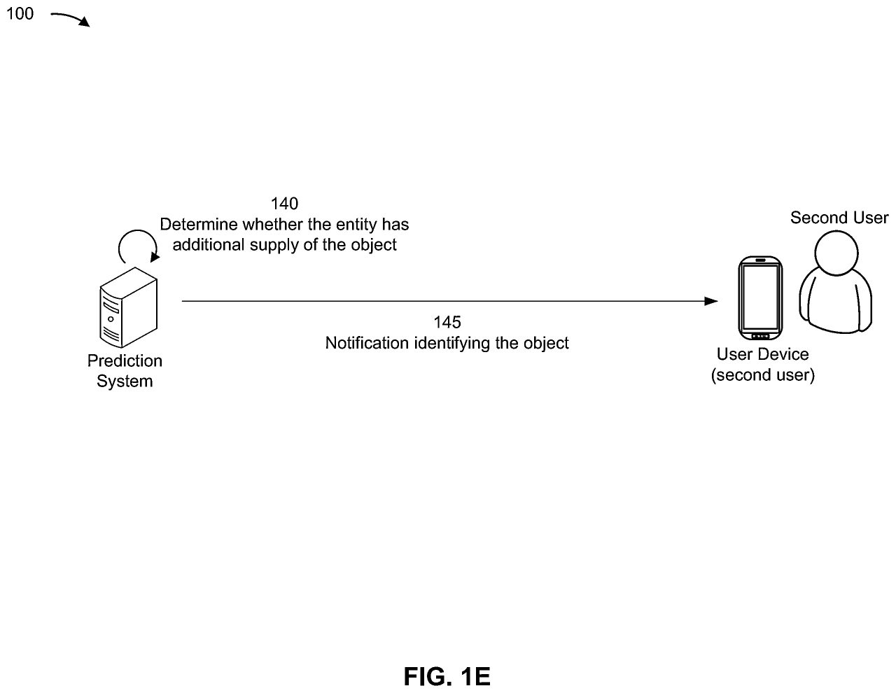

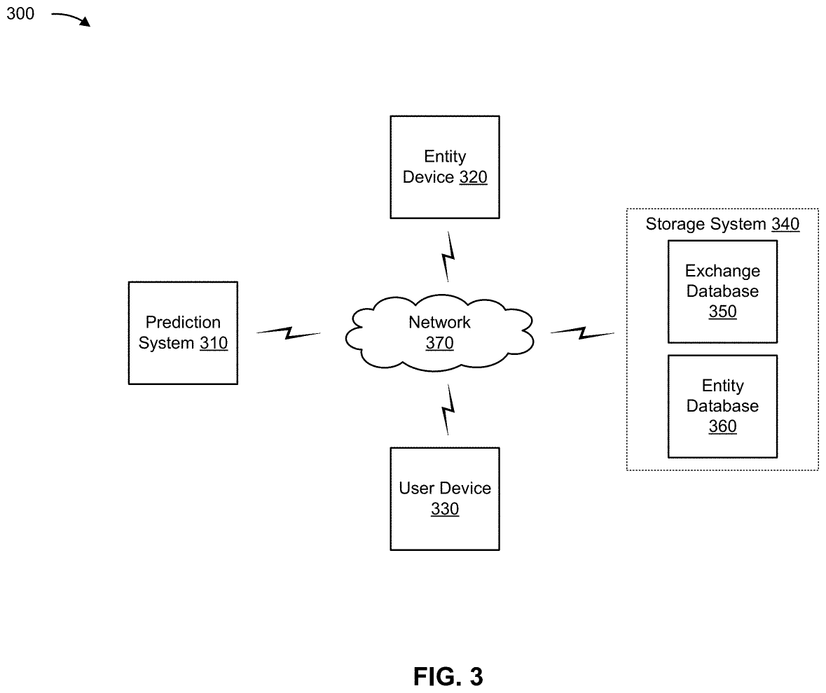

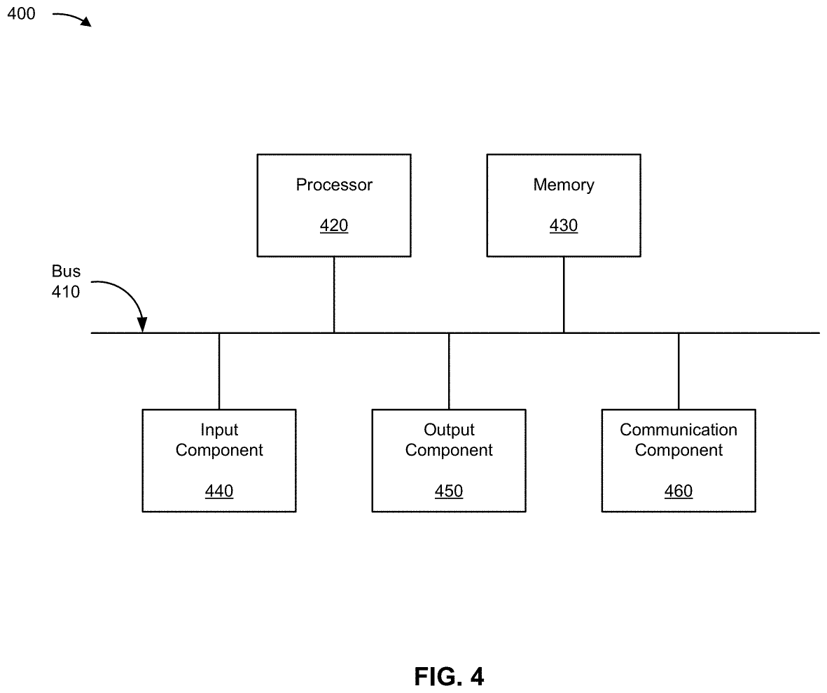

FIGS. 1A-1E are diagrams of an example 100 associated with prediction of interest in an object. As shown in FIGS. 1A-1E, example 100 includes a prediction system, one or more databases (e.g., an exchange database and/or an entity database, which may be included in a storage system), an entity device, and one or more user devices. These devices are described in more detail in connection with FIGS. 3 and 4.

As shown in FIG. 1A, and by reference number 105, the entity device may process an exchange (e.g., a transaction) for an object between a first user and an entity (e.g., the entity associated with the entity device). To process the exchange, the entity device may transmit exchange data relating to the exchange to a backend system for storage in the exchange database. The backend system may be, may be included in, or may be in communication with, the prediction system. The exchange data may identify the entity (e.g., using a merchant identifier, or the like), the user, an account (e.g., a financial account) associated with the user, an amount associated with the exchange, and/or the object (e.g., using an identifier of the object, such as stock keeping unit (SKU) information or a universal product code, among other examples).

As shown by reference number 110, the prediction system may identify the exchange associated with the object. For example, the prediction system may monitor exchanges to identify the exchange associated with the object. As an example, the prediction system may periodically obtain exchange data from the exchange database to monitor exchanges.

Based on monitoring the exchanges, the prediction system may identify the exchange associated with the object (e.g., select the exchange from among a plurality of exchanges that are monitored) based on the exchange data. For example, the prediction system may process the exchange data for the exchange to determine a type of the object associated with the exchange. In some implementations, the exchange data may include object-level information for the exchange (e.g., the object-level information of the exchange data may indicate that the exchange is associated with “apparel” or “groceries”), and the prediction system may determine the type of the object based on the object-level information. In some implementations, the exchange data may not include object-level information for the exchange, and the prediction system may determine the type of the object based on entity-level information. For example, the prediction system may process (e.g., using natural language processing) the entity-level information to determine the type of the object (e.g., the entity-level information of the exchange data may indicate that the entity involved in the exchange is “Main Street Antiques,” and therefore the prediction system may determine that the type of the object is “antiques”).

Additionally, or alternatively, the prediction system may determine the type of object associated with the exchange based on processing online reviews, a website, historical images (e.g., included in online reviews, captured by other users as described below, or the like), or the like, associated with the entity involved in the exchange. For example, these sources may indicate the types of objects that are available from the entity, from which the prediction system may infer the type of object associated with the exchange (e.g., the prediction system may infer that the type of object is a type that is most-frequently mentioned in the online reviews or most frequently depicted in the historical images).

The prediction system may identify the exchange associated with the object (e.g., select the exchange from among a plurality of exchanges that are monitored) based on a determination that the type of the object that is determined is recommendable to another user. For example, if the type of the object is groceries, the prediction system may determine that the object is not recommendable to another user, and the prediction system may not identify (e.g., select) the exchange associated with the object. As another example, if the type of the object is apparel, the prediction system may determine that the object is recommendable to another user, and the prediction system may identify (e.g., select) the exchange associated with the object. Additionally, or alternatively, the prediction system may identify (e.g., select) the exchange associated with the object based on whether an amount associated with the exchange satisfies a threshold (e.g., exchanges for amounts higher than the threshold may be cost-prohibitive and may not be recommendable to another user). For example, the prediction system may identify the exchange associated with the object if the amount associated with the exchange is less than $5000.

As shown in FIG. 1B, and by reference number 115, the prediction system may determine that the entity, associated with the exchange, is associated with at least one characteristic that satisfies a condition. The characteristic may relate to a size of the entity, a location of the entity, and/or a demographic characteristic associated with an owner of the entity, among other examples. In some implementations, the characteristic is an employee size of the entity, and the condition is that the employee size satisfies a threshold (e.g., the employee size is less than the threshold, such as 50 employees, 20 employees, 10 employees, or the like). Additionally, or alternatively, the characteristic is a quantity of physical locations of the entity, and the condition is that the quantity of physical locations satisfies a threshold (e.g., the quantity of physical locations is less than the threshold, such as 3 physical locations, 2 physical locations, or the like).

In some implementations, the prediction system may determine that the entity is associated with the characteristic that satisfies the condition based on a determination that the entity is associated with an entry in a data structure. For example, the prediction system may determine that the entity is associated with the characteristic that satisfies the condition based on a determination that the entity is associated with an entry in the entity database. As shown in FIG. 1B, the entity database (e.g., the data structure) may store entity data 120. The entity data 120 may identify a plurality of entities (e.g., merchants) that are associated with the characteristic that satisfies the condition (e.g., the plurality of entities may be small entities). The entity data 120 may include one or more entries, and an entry may identify an entity associated with the characteristic that satisfies the condition. In addition, the entry may identify a location of the entity (e.g., an address of the entity), a phone number for the entity, a category associated with the entity (e.g., that categorizes the types of objects offered by the entity), one or more particular object types offered by the entity, ratings of the entity, and/or one or more characteristics associated with the entity, such as a quantity of employees of the entity, a quantity of physical locations of the entity, demographic information associated with an owner of the entity, or the like.

The entity data 120 of the entity database may be obtained from or based on information that is publicly available. In some implementations, the prediction system may generate the entity database (e.g., the data structure) using the information. The prediction system may generate an entry for an entity in the entity database based on a determination that the entity is associated with the characteristic that satisfies the condition. The prediction system may determine that the entity is associated with the characteristic that satisfies the condition, and/or determine the particular object types offered by the entity, based on the information.

The information may include information in one or more reviews of the entity. For example, the prediction system may obtain online reviews of the entity using a web scraping technique, and the prediction system may process the reviews using natural language processing to identify types of objects offered by the entity and/or to identify whether the entity is described as being associated with the characteristic that satisfies the condition (e.g., described as being a small entity, for example, by descriptions such as “small business,” “local business,” “mom and pop,” or the like). Additionally, or alternatively, the information may include one or more images of objects that are available from the entity. For example, the images may be included in online reviews of the entity, on a website of the entity, or the like. The prediction system may process the images, for example using a computer vision technique, to identify types of objects depicted in the images and/or to determine if objects depicted in the images are indicative of the entity being associated with the characteristic that satisfies the condition. For example, images depicting custom objects, antiques, small quantities of objects, or the like, may be indicative of a small entity.

Additionally, or alternatively, the information may include one or more images of a building associated with the entity. For example, the images may be included in online reviews of the entity, on a website of the entity, or the like. The prediction system may process the images, for example using a computer vision technique, to determine whether a size of the building, signage on the building, or the like, is indicative of the entity being associated with the characteristic that satisfies the condition. For example, images depicting a small building and/or a building with handwritten signage may be indicative of a small entity. Additionally, or alternatively, the information may include information relating to the entity in a registry of entities (e.g., a state, county, or city business registry, a Small Business Administration registry, or the like).

Additionally, or alternatively, the information may include historical exchange (e.g., transaction) data relating to the entity. For example, the prediction system may process the historical exchange data to determine whether a quantity of exchanges associated with the entity, a value of exchanges associated with the entity, one or more locations of exchanges associated with the entity, or the like, is indicative of the entity being associated with the characteristic that satisfies the condition. As an example, a large entity may be associated with a quantity or a value of exchanges over a time period (e.g., a day, a week, a month, or the like) that is above a threshold and a small entity may be associated with a quantity or a value of exchanges over the time period that is below the threshold. As another example, a large entity may be associated with exchanges occurring in a quantity of locations that is above a threshold, or in locations separated by a threshold distance, and a small entity may be associated with exchanges occurring in a quantity of locations that is below the threshold, or in locations that are not separated by the threshold distance.

In some implementations, the prediction system may obtain the information described above in real time (e.g., upon identifying the exchange associated with the entity). Moreover, the prediction system may perform the processing described above in real time to determine whether the entity is associated with the characteristic that satisfies the condition.

As shown in FIG. 1C, and by reference number 125, the prediction system may transmit a notification, to the user device of the first user, prompting the first user to provide information associated with the object. In some implementations, the information may include an image of the object (e.g., the notification may prompt the first user to capture an image of the object). In some implementations, the information may include a description of the object and/or one or more tags associated with the object (e.g., indicating keywords and/or categories associated with the object), among other examples. The prediction system may transmit the notification to the user device of the first user based on determining that the entity associated with the exchange is associated with the characteristic that satisfies the condition. Based on receiving the notification, the first user may capture an image of the object using the user device and/or the first user may input information to the user device.

As shown by reference number 130, the prediction system may receive, from the user device of the first user, the information associated with the object. That is, the prediction system may receive the information associated with the object in response to the notification transmitted by the prediction system. As described above, the information received by the prediction system may include an image of the object (e.g., one or more images, one or more videos, or the like), a description of the object, and/or one or more tags associated with the object, among other examples.

As shown in FIG. 1D, and by reference number 135, the prediction system may determine a second user predicted to have a level of interest in the object that satisfies a threshold. For example, the prediction system may determine the second user based on the information associated with the object received from the first user (e.g., based on the image of the object received from the first user). That is, the prediction system may predict the second user's level of interest in the object based on the information associated with the object.

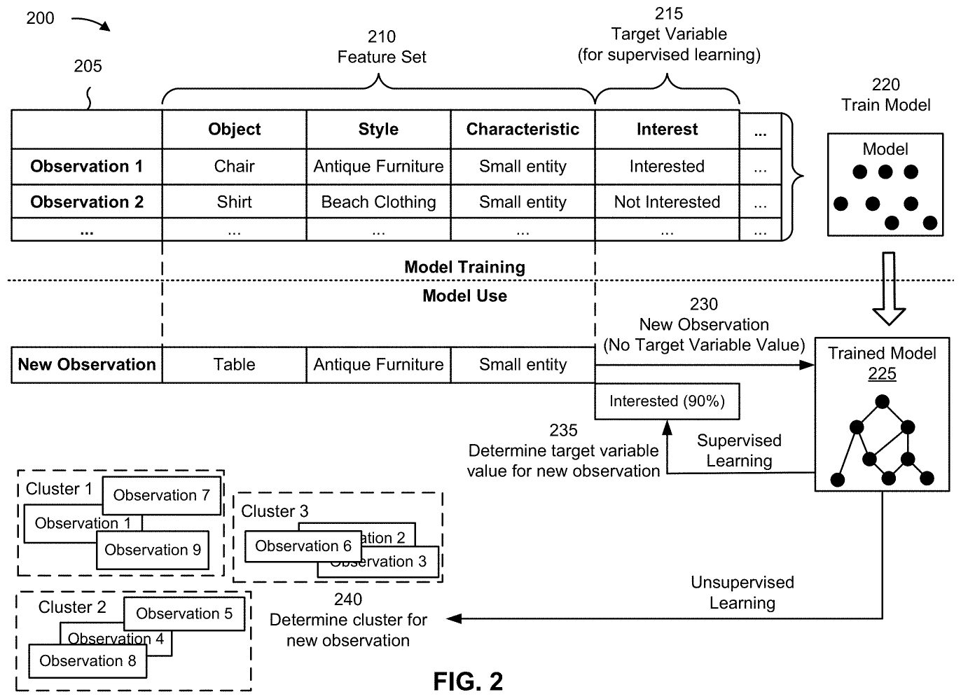

In some implementations, the prediction system may analyze the information associated with the object (e.g., the image) received from the first user to classify the object (e.g., according to a type of the object, a subject of the object, and/or a style of the object). In some implementations, the prediction system may use a machine learning model to classify the object, in a similar manner as described below in connection with FIG. 2. The machine learning model may be a computer vision model (e.g., that includes a convolutional neural network and/or a recurrent neural network). For example, the computer vision model may be trained based on one or more parameters for classifying an object depicted in an image, such as parameters associated with an object type of the object (e.g., a shape, a size, an arrangement, or an association with other objects), parameters associated with a style of the object (e.g., a color, a color palette, a pattern, a design, an aesthetic, and/or an arrangement with other objects associated with the style), and/or parameters associated with a subject (e.g., a particular industry or topic, such as fashion, home décor, travel, art, architecture) of the object (e.g., indicators of a subject and/or objects types associated with a subject).

In some implementations, the prediction system may predict the second user's level of interest in the object (e.g., the prediction system may predict respective levels of interest in the object, shown in FIG. 1D as an “interest score,” for a plurality of users). The second user's level of interest in the object may be predicted based on historical data, such as historical online browsing data and/or historical social media posting data for the second user indicative of a preference of the second user for objects associated with a particular type, style, or subject and/or entities associated with the characteristic that satisfies the condition. Additionally, or alternatively, the second user's level of interest in the object may be predicted based on historical exchange data for the second user indicative of a preference of the second user for exchanges for objects of a particular type, style, or subject and/or exchanges with entities associated with the characteristic that satisfies the condition.

To predict the second user's level of interest in the object, the prediction system may use a machine learning model trained to identify levels of interest in the object associated with a plurality of users based on the style of the object and/or the characteristic of the entity, in a similar manner as described below in connection with FIG. 2. For example, the machine learning model may be trained based on one or more parameters for identifying a level of interest in an object, such as parameters associated with object style, as described above, entity characteristics (e.g., a quantity of employees of an entity, a quantity of physical locations of an entity, or the like), and activity of a user (e.g., online browsing activity, social media activity, exchange activity, or the like). The activity of the user may include metrics such as an amount of time the user engaged in browsing relating to a particular object type, entity type, style, or subject, a quantity of posts by the user relating to a particular object type, entity type, style, or subject, a frequency of browsing or posting relating to a particular object type, entity type, style, or subject, a quantity of exchanges of the user involving a particular object type, entity type, style, or subject, a value of exchanges of the user involving a particular object type, entity type, style, or subject, or the like. In some implementations, the machine learning model may be trained to identify a user's level of interest in an entity having the characteristic that satisfies the threshold (e.g., and therefore the user having interest in an object offered by the entity) based on whether the user previously executed a transaction for an object recommended to the user by the prediction system and/or whether the user interacted with (e.g., opened, read, followed a link, or the like) a notification transmitted by the prediction system that recommended an object.

The prediction system (e.g., via the machine learning model) may determine the second user's preference for a particular style over other styles and/or the second user's preference for a particular entity type (e.g., a small entity) over other entity types. Accordingly, the prediction system, using the machine learning model, may determine a level of interest that the second user has in the object associated with the exchange. In some implementations, the prediction system may determine whether the second user's predicted level of interest satisfies a threshold (e.g., the level of interest satisfying the threshold indicating that the second user has a preference for the object from the entity over other objects or over the same object from different entities).

In some implementations, the prediction system may use a first machine learning model, as described above, to determine the classification of the object based on the information received from the first user, and a second machine learning model, as described above, to determine the second user's level of interest in the object based on the classification of the object determined using the first machine learning model. In some implementations, the prediction system may use a single machine learning model to determine the second user's level of interest in the object based on the information associated with the object received from the first user. For example, the machine learning model (e.g., a computer vision model, for example, that includes a convolutional neural network and/or a recurrent neural network) may be trained to predict a level of interest that a user has in an object depicted in an image (e.g., using one or more of the parameters described above for classification of an object and/or prediction of a level of interest). In some implementations, the prediction system may use a technique other than machine learning for predicting a level of interest in the object, such as a weighted scoring system.

As shown in FIG. 1E, and by reference number 140, the prediction system may determine whether the entity associated with the exchange has additional supply of the object associated with the exchange. For example, in the case of objects that are limited edition, produced in small batches, or the like, the prediction system may confirm that the entity has additional supply of the object before recommending the object to the second user.

In some implementations, to determine whether the entity has additional supply of the object, the prediction system may initiate an automated communication to the entity. The automated communication may include a voice call, a video call, a text message, and/or an email message, among other examples. The automated communication may request the entity to provide information relating to the entity's additional supply of the object. In some implementations, the automated communication may use a conversational artificial intelligence technique (e.g., a chat bot technique) to engage in a conversation with the entity (e.g., an individual associated with the entity). The entity (e.g., an individual associated with the entity) may provide a response, to the automated communication, providing information relating to the additional supply of the object. For example, the response may be a verbal response in a voice or video call, a text message response, and/or an email message response. The prediction system may determine whether the entity has additional supply of the object based on the response. For example, the prediction system may use the conversational artificial intelligence technique, natural language processing, or the like, to determine whether the entity has additional supply of the object based on the response.

Additionally, or alternatively, to determine whether the entity has additional supply of the object, the prediction system may process a content of a web page of the entity that is associated with the object. The web page associated with the object may include a web page that includes information relating to the object, a web page that enables selection of the object for purchase, a web page that enables purchase of the object, or the like. For example, the web page may include content indicating a quantity of the object that is available, whether the object is in low stock, whether the object is sold out, or the like. The prediction may determine whether the entity has additional supply of the object based on the content of the web page. For example, the prediction system may perform natural language processing of the content to determine whether the entity has additional supply of the object.

Additionally, or alternatively, the prediction system may determine whether the entity has additional supply of the object based on historical exchange data associated with the entity. The historical exchange data may include information relating to historical exchanges involving the entity and the object. The prediction system, using the historical exchange data, may determine a historical quantity of exchanges associated with the object that occurred in a historical time period (e.g., occurred over a previous week, a previous month, or the like). The historical quantity of exchanges may indicate a minimum supply of the object that is available from the entity. In addition, the prediction system may determine whether a current quantity of exchanges associated with the object that have occurred in a current time period (e.g., occurred to date in a current week, a current month, or the like) is less than the historical quantity of exchanges. The current quantity of exchanges being less than the historical quantity of exchanges may indicate that the entity has additional supply of the object (e.g., the additional supply being equal to the difference of the historical quantity of exchanges and the current quantity of exchanges). Thus, the prediction system may determine whether the entity has additional supply of the object based on whether the current quantity of exchanges is less than the historical quantity of exchanges.

In some implementations, the prediction system may cause execution of another exchange for the object (e.g., on behalf of the second user). The prediction system may cause execution of the exchange based on determining that the entity has additional supply of the object. In some implementations, the prediction system may cause execution of the exchange based on determining that the predicted level of interest in the object associated with the second user, and/or one or more other users, satisfies a stricter threshold (e.g., the second user is very likely to be interested in the object) and/or determining that a quantity of users associated with the threshold level of interest in the object satisfies a threshold (e.g., there are many users likely to be interested in the object). The prediction system may cause execution of the exchange by initiating an order for the object via the automated communication to the entity or another automated communication, via a website of the entity, via an application programming interface (API) of the entity, or the like.

As shown by reference number 145, the prediction system may transmit, to a user device of the second user, a notification identifying the object. The prediction system may transmit the notification based on determining the second user (e.g., that is predicted to have a level of interest in the object that satisfies the threshold). Additionally, or alternatively, the prediction system may transmit the notification based on determining that the entity has additional supply of the object. The notification may include information relating to the object (e.g., the picture of the object, the description of the object, the one or more tags associated with the object, and/or a price of the object among other examples) and/or the entity (e.g., the location of the entity and/or the characteristic of the entity, among other examples).

In some implementations, the notification may include an input element to enable the second user to execute an exchange for the object. For example, the input element may enable the second user to execute the exchange with the entity (e.g., via a website of the entity, an API of the entity, or the like). As another example, the input element may enable the second user to execute the exchange via the prediction system. That is, if the prediction system previously caused execution of an exchange for the object (e.g., on behalf of the second user), the exchange enabled by the input element may be between the second user and an entity associated with the prediction system. In some implementations, to execute the exchange via the prediction system, the input element may enable the user device of the second user to transmit a request for executing an exchange for the object to the prediction system. Based on receiving the request, the prediction system may cause execution of the exchange. For example, the prediction system may cause execution of the exchange by initiating an order for the object via a website of the entity, via an API of the entity, or the like. As another example, the prediction system may cause execution of the exchange by initiating an exchange for the object via a courier service (e.g., via a website, an application, or an API of the courier service).

In this way, the prediction system facilitates exchanges for objects without a need to enter and remove information relating to the objects from a backend system, thereby conserving computing resources and/or network resources associated with entering and removing the information. Moreover, the prediction system accurately determines a level of interest that a user may have in an object and may provide information about the object to the user based on the determination, thereby conserving computing resources and/or network resources that would otherwise be consumed using a system that does not accurately determine a level of interest that a user may have in an object.

As indicated above, FIGS. 1A-1E are provided as an example. Other examples may differ from what is described with regard to FIGS. 1A-1E.

FIG. 2 is a diagram illustrating an example 200 of training and using a machine learning model in connection with prediction of interest in an object. The machine learning model training and usage described herein may be performed using a machine learning system. The machine learning system may include or may be included in a computing device, a server, a cloud computing environment, or the like, such as the prediction system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the exchange database and/or the entity database, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the prediction system, the exchange database, and/or the entity database. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of object, a second feature of style (of the object), a third feature of characteristic (of the entity offering the object), and so on. As shown, for a first observation, the first feature may have a value of chair, the second feature may have a value of antique furniture, the third feature may have a value of small entity, and so on. These features and feature values are provided as examples and may differ in other examples. For example, the feature set may include one or more of the following features: object classification, object type, object style, object subject, object color, object size, one or more user online browsing activity metrics, one or more user social media posting activity metrics, one or more user exchange activity metrics, entity size classification, quantity of employees of the entity, quantity of physical locations of the entity, one or more demographic classifications for an owner of the entity, or the like.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is interest, which has a value of interested for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature value of table, a second feature value of antique furniture, a third feature value of small entity, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of interested (e.g., with a confidence score of 90%) for the target variable of interest for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., interested), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., not interested), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In this way, the machine learning system may apply a rigorous and automated process to predict interest in an object. The machine learning system enables recognition and/or identification of tens, hundreds, thousands, or millions of features and/or feature values for tens, hundreds, thousands, or millions of observations, thereby increasing accuracy and consistency and reducing delay associated with predicting interest in an object relative to requiring computing resources to be allocated for tens, hundreds, or thousands of operators to manually predict interest in an object using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a prediction system 310, an entity device 320, a user device 330, a storage system 340 (e.g., that includes an exchange database 350 and/or an entity database 360), and a network 370. Devices of environment 300 may interconnect via wired connections, wireless connections, or a combination of wired and wireless connections.

The prediction system 310 includes one or more devices capable of receiving, generating, storing, processing, providing, and/or routing information associated with prediction of interest in an object, as described elsewhere herein. The prediction system 310 may include a communication device and/or a computing device. For example, the prediction system 310 may include a server, such as an application server, a client server, a web server, a database server, a host server, a proxy server, a virtual server (e.g., executing on computing hardware), or a server in a cloud computing system. In some implementations, the prediction system 310 includes computing hardware used in a cloud computing environment.

The entity device 320 includes one or more devices capable of facilitating an electronic transaction. For example, the entity device 320 may include a point-of-sale (PoS) terminal, a payment terminal (e.g., a credit card terminal, a contactless payment terminal, a mobile credit card reader, or a chip reader), and/or an automated teller machine (ATM). The entity device 320 may include one or more input components and/or one or more output components to facilitate obtaining data (e.g., account information) from a transaction device (e.g., a transaction card, a mobile device executing a payment application, or the like) and/or to facilitate interaction with and/or authorization from an owner or accountholder of the transaction device. Example input components of the entity device 320 include a number keypad, a touchscreen, a magnetic stripe reader, a chip reader, and/or a radio frequency (RF) signal reader (e.g., a near-field communication (NFC) reader). Example output devices of entity device 320 include a display and/or a speaker.

The user device 330 includes one or more devices capable of receiving, generating, storing, processing, and/or providing information associated with prediction of interest in an object, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. As described above, the user device may be associated with a user that performed an exchange for an object or a user that is to receive a notification recommending the object.

The storage system 340 includes one or more devices capable of receiving, generating, storing, processing, and/or providing information associated with prediction of interest in an object t, as described elsewhere herein. The storage system 340 may include a communication device and/or a computing device. For example, the storage system 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the storage system 340 may include the exchange database 350 and/or the entity database 360. The storage system 340 may communicate with one or more other devices of environment 300, as described elsewhere herein.

The network 370 includes one or more wired and/or wireless networks. For example, the network 370 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 370 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the prediction system 310, the entity device 320, the user device 330, and/or the storage system 340. In some implementations, prediction system 310, the entity device 320, the user device 330, and/or the storage system 340 may include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

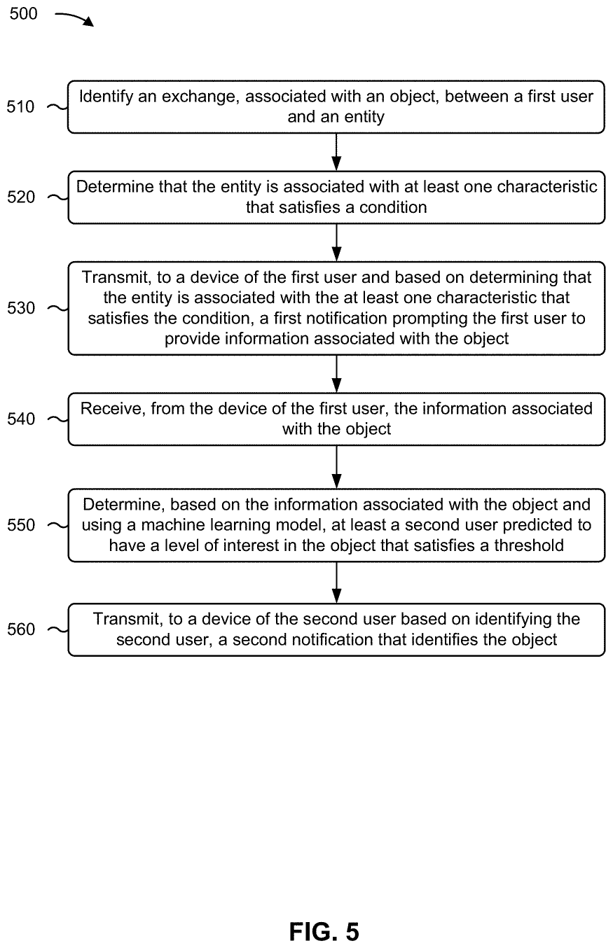

FIG. 5 is a flowchart of an example process 500 associated with prediction of interest in an object. In some implementations, one or more process blocks of FIG. 5 may be performed by a device (e.g., prediction system 310). In some implementations, one or more process blocks of FIG. 5 may be performed by another device or a group of devices separate from or including the device, such as entity device 320, user device 330, and/or storage system 340. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include identifying an exchange, associated with an object, between a first user and an entity (block 510). As further shown in FIG. 5, process 500 may include determining that the entity is associated with at least one characteristic that satisfies a condition (block 520). As further shown in FIG. 5, process 500 may include transmitting, to a device of the first user and based on determining that the entity is associated with the at least one characteristic that satisfies the condition, a first notification prompting the first user to provide information associated with the object (block 530). As further shown in FIG. 5, process 500 may include receiving, from the device of the first user, the information associated with the object (block 540). As further shown in FIG. 5, process 500 may include determining based on the information associated with the object and using a machine learning model, at least a second user predicted to have a level of interest in the object that satisfies a threshold (block 550). In some implementations, the machine learning model is trained to identify levels of interest in the object associated with a plurality of users based on the at least one characteristic of the entity. As further shown in FIG. 5, process 500 may include transmitting, to a device of the second user based on identifying the second user, a second notification that identifies the object (block 560).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for predicting interest in an object, the system comprising:
one or more memories; and
one or more processors, communicatively coupled to the one or more memories, configured to:
identify an exchange, associated with the object, between a first user and an entity;
determine, based on using a computer vision technique to analyze one or more images, whether one or more objects, including the object, depicted in the one or more images are indicative of the entity being associated with at least one characteristic that satisfies a condition;
transmit, to a first device of the first user and based on determining that the entity is associated with the at least one characteristic that satisfies the condition, a first notification prompting the first user to capture an image of the object;
receive, from the first device of the first user, the image of the object that is captured by the first device of the first user;
determine, based on the image and using a machine learning model, at least a second user predicted to have a level of interest in the object that satisfies a threshold,
wherein the machine learning model is trained to identify levels of interest in the object associated with a plurality of users based on a style of the object and the at least one characteristic of the entity;
determine whether the entity has additional supply of the object; and
transmit, to a second device of the second user based on determining the second user and determining that the entity has the additional supply of the object, a second notification that identifies the object.

2. The system of claim 1, wherein the one or more processors, to determine whether the entity has the additional supply of the object, are configured to:
initiate an automated communication to the entity; and
determine whether the entity has the additional supply of the object based on a response to the automated communication.

3. The system of claim 1, wherein the one or more processors, to determine whether the entity has the additional supply of the object, are configured to:
process a content of a web page of the entity that is associated with the object; and
determine whether the entity has the additional supply of the object based on the content of the web page.

4. The system of claim 1, wherein the one or more processors, to determine whether the entity has the additional supply of the object, are configured to:
determine a historical quantity of exchanges associated with the object that occurred in a historical time period; and
determine whether the entity has the additional supply of the object based on whether a current quantity of exchanges associated with the object that have occurred in a current time period is less than the historical quantity of exchanges.

5. The system of claim 1, wherein the level of interest in the object of the second user is predicted based on historical exchange data, associated with the second user, indicative of a preference of the second user for exchanges with entities associated with the at least one characteristic that satisfies the condition.

6. The system of claim 1, wherein the at least one characteristic is an employee size of the entity and the condition is that the employee size satisfies a size threshold, or
wherein the at least one characteristic is a quantity of physical locations of the entity and the condition is that the quantity of physical locations satisfies a quantity threshold.

7. The system of claim 1, wherein the machine learning model comprises a computer vision model that includes at least one of a convolutional neural network or a recurrent neural network.

8. A method of predicting interest in an object, comprising:
identifying, by a device, an exchange, associated with the object, between a first user and an entity;
determining, by the device and based on using a computer vision technique to analyze one or more images, whether one or more objects, including the object, depicted in the one or more images are indicative of the entity being associated with at least one characteristic that satisfies a condition;
transmitting, to a first device of the first user and based on determining that the entity is associated with the at least one characteristic that satisfies the condition, a first notification prompting the first user to provide information associated with the object;
receiving, by the device from the first device of the first user, the information associated with the object;
determining, by the device, based on the information associated with the object and using a machine learning model, at least a second user predicted to have a level of interest in the object that satisfies a threshold,
wherein the machine learning model is trained to identify levels of interest in the object associated with a plurality of users based on the at least one characteristic of the entity; and
transmitting, by the device to a second device of the second user based on determining the second user, a second notification that identifies the object.

9. The method of claim 8, wherein the second notification includes an input element to enable the second user to execute another exchange for the object.

10. The method of claim 8, further comprising:
determining whether the entity has additional supply of the object,
wherein the second notification is transmitted based on determining that the entity has the additional supply of the object.

11. The method of claim 10, wherein determining whether the entity has the additional supply of the object comprises:
initiating an automated communication to the entity; and
determining whether the entity has the additional supply of the object based on a response to the automated communication.

12. The method of claim 8, further comprising:
causing, based on identifying the second user, execution of another exchange for the object.

13. The method of claim 8, wherein the information associated with the object includes one or more of:
an image of the object,
a description of the object, or
one or more tags associated with the object.

14. The method of claim 8, wherein the at least one characteristic is an employee size of the entity and the condition is that the employee size satisfies a size threshold, or
wherein the at least one characteristic is a quantity of physical locations of the entity and the condition is that the quantity of physical locations satisfies a quantity threshold.

15. A non-transitory computer-readable medium storing a set of instructions for predicting interest in an object, the set of instructions comprising:
one or more instructions that, when executed by one or more processors of a device, cause the device to:
identify an exchange, associated with the object, between a first user and an entity;
determine, based on using a computer vision technique to analyze one or more images, whether one or more objects, including the object, depicted in the one or more images are indicative of the entity being associated with at least one characteristic that satisfies a condition;
transmit, to a first device of the first user and based on determining that the entity is associated with the at least one characteristic that satisfies the condition, a first notification prompting the first user to capture an image of the object;
receive, from the first device of the first user, the image of the object that is captured by the first device of the first user;
determine, based on the image, at least a second user predicted to have a level of interest in the object that satisfies a threshold; and
transmit, to a second device of the second user based on determining the second user, a second notification that identifies the object.

16. The non-transitory computer-readable medium of claim 15, wherein the one or more instructions, that cause the device to determine that the entity is associated with the at least one characteristic that satisfies the condition, cause the device to:
determine whether the entity is associated with an entry in a data structure,
wherein the data structure includes entries for a plurality of entities associated with the at least one characteristic that satisfies the condition.

17. The non-transitory computer-readable medium of claim 15, wherein the one or more instructions, when executed by the one or more processors, further cause the device to:
generate a data structure that includes entries for a plurality of entities associated with the at least one characteristic that satisfies the condition.

18. The non-transitory computer-readable medium of claim 17, wherein the one or more instructions, that cause the device to generate the data structure, cause the device to:
determine that an individual entity, of the plurality of entities, has the at least one characteristic that satisfies the condition based on one or more of:
information in one or more reviews of the individual entity,
one or more images of objects that are available from the individual entity,
one or more images of a building associated with the individual entity,
information relating to the individual entity in a registry of entities, or
historical exchange data relating to the individual entity; and
generate an entry for the individual entity in the data structure based on determining that the individual entity has the at least one characteristic that satisfies the condition.

19. The non-transitory computer-readable medium of claim 15, wherein the level of interest in the object of the second user is predicted based on historical exchange data, associated with the second user, indicative of a preference of the second user for exchanges with entities associated with the at least one characteristic that satisfies the condition.

20. The non-transitory computer-readable medium of claim 15, wherein the at least one characteristic is an employee size of the entity and the condition is that the employee size satisfies a size threshold, or
wherein the at least one characteristic is a quantity of physical locations of the entity and the condition is that the quantity of physical locations satisfies a quantity threshold.
